(19) United States
(12) Patent Application Publication
(10) Pub. No.: US 2023/0155174 A1
(43) Pub. Date: May 18, 2023

(54) LITHIUM METAL BATTERY ELECTROLYTES INCLUDING FLAME RETARDANT ADDITIVES

(71) Applicant: GM GLOBAL TECHNOLOGY OPERATIONS LLC, Detroit, MI (US)

(72) Inventors: Seung-Woo Chu, Clawson, MI (US); Li Yang, Troy, MI (US); Umamaheswari Viswanathan, Troy, MI (US); Mary E Fortier, Troy, MI (US)

(73) Assignee: GM GLOBAL TECHNOLOGY OPERATIONS LLC, Detroit, MI (US)

(21) Appl. No.: 17/525,115

(22) Filed: Nov. 12, 2021

(51) Int. Cl. H01M 10/0567; H01M 10/0568; H01M 10/0569; H01M 10/0525

(52) U.S. Cl. CPC H01M 10/0567; H01M 10/0568; H01M 10/0569; H01M 10/0525; H01M 2300/0028

(57) ABSTRACT

An electrolyte for a lithium metal battery includes a nonaqueous aprotic organic solvent, a lithium salt dissolved in the nonaqueous aprotic organic solvent and, by volume, from 1% to 10% of a flame retardant additive. The flame retardant additive is at least one of an organophosphate compound, an organophosphite compound, organophosphonate compound, or a phosphazene compound.

### INTRODUCTION

The present disclosure relates to secondary lithium metal batteries and, more particularly, to liquid electrolytes for lithium metal batteries that enhance the flame retardant performance thereof.

Electrochemical cells of secondary lithium batteries generally include a negative electrode and a positive electrode spaced apart from one another by a porous separator. The negative and positive electrodes and the porous separator are infiltrated with an ionically conductive electrolyte that provides a medium for the conduction of lithium ions between the negative and positive electrodes during discharge and recharge of the electrochemical cell. Electrolytes of lithium batteries generally comprise a lithium salt dissolved or dispersed in one or more aprotic organic solvents and may be formulated to exhibit certain desirable properties over a wide operating temperature range. Such desirable properties may include high ionic conductivity, low viscosity, non-flammability, a wide electrochemical stability window, and chemical compatibility with the other components of the electrochemical cell.

Manufacturing defects, aging, and/or certain abuse conditions may impair the thermal stability of secondary lithium batteries. Certain conditions that increase the internal temperature of lithium batteries may set-off undesirable events and/or chemical reactions within the batteries that may lead to further undesirable heat generation. Because components of lithium batteries and/or of their surrounding environment may be flammable, it may be desirable to incorporate materials into the internal components of such batteries that can effectively inhibit propagation of combustion chain reactions.

### SUMMARY

An electrolyte for a lithium metal battery is disclosed. The electrolyte includes a nonaqueous aprotic organic solvent, a lithium salt dissolved in the nonaqueous aprotic organic solvent, and from 1% to 10%, by volume, of a flame retardant additive. The flame retardant additive is at least one of an organophosphate compound, an organophosphite compound, organophosphonate compound, or a phosphazene compound.

The flame retardant additive may include at least one of tris(2,2,2-trifluoroethyl) phosphate; tris(2,2,2-trifluoroethyl) phosphite; triphenyl phosphite; diethyl ethylphosphonate; diethyl phenylphosphonate; 2-ethoxy-2,4,4,6,6-pentafluoro-1,3,5,2,4,6-triazatriphosphorine; or pentafluoro(phenoxy)cyclotriphosphazene.

The nonaqueous aprotic organic solvent may include at least one of dimethoxy ethane, dimethoxy propane, ethylene carbonate, propylene carbonate, or fluoroethylene carbonate. The nonaqueous aprotic organic solvent may constitute, by volume, from 10% to 90% of the electrolyte.

The electrolyte may include a diluent. The diluent may be at least one of 1,1,2,2-tetrafluoroethyl-2,2,3,3-tetrafluoropropyl ether (TTE); 1,2,2,2-tetrafluoroethyl methyl ether; n-Butyl-1,1,2,2-tetrafluoroethyl ether; 1H,1H,2′H,3H-Decafluorodipropyl ether; bis(2,2,2-trifluoroethyl)ether; ethyl 1,1,2,2-tetrafluoroethyl ether; difluoromethyl-2,2,3,3,3-pentafluoropropyl ether; 2,2,2-trifluoroethyl 1,1,2,2-tetrafluoroethyl ether; difluoromethyl 2,2,3,3-tetrafluoropropyl ether; propyl 1,1,2,2-tetrafluoroethyl ether; 1,1-difluoroethyl 2,2,2-trifluoroethyl ether; isopropyl 1,1,2,2-tetrafluoroethyl ether; bis(2,2-difluoroethyl)ether; or 1,1,2,2-tetrafluoroethyl isobutyl ether. The diluent may constitute, by volume, from 10% to 89% of the electrolyte.

The lithium salt may be at least one of lithium bis(fluorosulfonyl)imide; lithium hexafluorophosphate; lithium perchlorate; lithium tetrachloroaluminate; lithium iodide; lithium bromide; lithium thiocyanate; lithium tetrafluoroborate; lithium tetraphenylborate; lithium hexafluoroarsenate; lithium trifluoromethanesulfonate; lithium bis(fluorosulfonyl)imide; lithium bis(trifluoromethylsulfonyl)imide; lithium bis(oxalate) borate; lithium difluoro(oxalato)borate; lithium tris(pentafluoroethyl)-trifluorophosphate; lithium bis(trifluoromethyl)-tetrafluorophosphate; lithium tetrafluorooxalatophosphate; lithium tris(trifluoromethyl)trifluorophosphate; lithium trifluoromethanesulfonate; or lithium nitrate. A molar concentration of the lithium salt in the electrolyte may be in a range of from 0.5 M to 5.0 M.

An electrochemical cell for a lithium metal battery is disclosed. The electrochemical cell includes a lithium metal negative electrode, a positive electrode spaced apart from the negative electrode, and an electrolyte in ionic contact with the lithium metal negative electrode and the positive electrode. The positive electrode includes a transition metal oxide that can undergo a reversible intercalation of lithium ions. The electrolyte includes: a nonaqueous aprotic organic solvent, a lithium salt dissolved in the nonaqueous aprotic organic solvent, and 1% to 10%, by volume, of a flame retardant additive. The flame retardant additive is at least one of an organophosphate compound, an organophosphite compound, organophosphonate compound, or a phosphazene compound.

The flame retardant additive may be an organophosphate compound represented by the chemical formula:

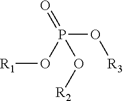

wherein R₁, R₂, and R₃ are each individually a C1-C4 alkyl group or an aryl group having 5 to 6 carbon atoms. In such case, the flame retardant additive may be tris(2,2,2-trifluoroethyl) phosphate.

The flame retardant additive may be an organophosphite compound represented by the chemical formula:

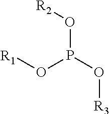

wherein R₁, R₂, and R₃ are each individually a C1-C4 alkyl group or an aryl group having 5 to 6 carbon atoms. In such case, the flame retardant additive may be at least one of tris(2,2,2-trifluoroethyl) phosphite or triphenyl phosphite.

The flame retardant additive may be an organophosphonate compound represented by the chemical formula:

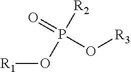

wherein R₁, R₂, and R₃ are each individually a C1-C4 alkyl group or an aryl group having 5 to 6 carbon atoms. In such case, the flame retardant additive is at least one of diethyl ethylphosphonate or diethyl phenylphosphonate.

The flame retardant additive may be an aryl phosphazene compound represented by the chemical formula:

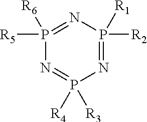

wherein R₁, R₂, R₃, R₄, R₅, and R₆ are each individually a fluorine atom, a C1-C4 alkyl group, a C1-C4 alkoxy group, an aryl group having 5 to 6 carbon atoms, or an aryloxy group having 5 to 6 carbon atoms. In such case, the flame retardant additive may be at least one of 2-ethoxy-2,4,4,6,6-pentafluoro-1,3,5,2,4,6-triazatriphosphorine or pentafluoro(phenoxy)cyclotriphosphazene.

The transition metal oxide of the positive electrode may be a high-nickel content lithium nickel cobalt manganese oxide having the chemical formula: LiNi_{1-a-b}CoₐMn_{b}O₂, wherein a=0.1-0.2 and b=0.1-0.2. In such case, the nonaqueous aprotic organic solvent in the electrolyte may be at least one of dimethoxy ethane or dimethoxy propane, and the electrolyte may comprise, by volume, less than 5% of a carbonate-based organic solvent selected from the group consisting of ethylene carbonate, propylene carbonate, dimethyl carbonate, diethyl carbonate, ethyl methyl carbonate, and fluoroethylene carbonate.

The lithium salt in the electrolyte may be at least one of lithium bis(fluorosulfonyl)imide; lithium hexafluorophosphate; lithium perchlorate; lithium tetrachloroaluminate; lithium iodide; lithium bromide; lithium thiocyanate; lithium tetrafluoroborate; lithium tetraphenylborate; lithium hexafluoroarsenate; lithium trifluoromethanesulfonate; lithium bis(fluorosulfonyl)imide; lithium bis(trifluoromethylsulfonyl)imide; lithium bis(oxalate) borate; lithium difluoro(oxalato)borate; lithium tris(pentafluoroethyl)-trifluorophosphate; lithium bis(trifluoromethyl)-tetrafluorophosphate; lithium tetrafluorooxalatophosphate; lithium tris(trifluoromethyl)trifluorophosphate; lithium trifluoromethanesulfonate; or lithium nitrate.

The lithium metal negative electrode may comprise, by weight, greater than 97% lithium.

The electrolyte may include a diluent. In such case, the diluent may be at least one of 1,1,2,2-tetrafluoroethyl-2,2,3,3-tetrafluoropropyl ether (TTE); 1,2,2,2-tetrafluoroethyl methyl ether; n-Butyl-1,1,2,2-tetrafluoroethyl ether; 1H,1H,2′H,3H-Decafluorodipropyl ether; bis(2,2,2-trifluoroethyl)ether; ethyl 1,1,2,2-tetrafluoroethyl ether; difluoromethyl-2,2,3,3,3-pentafluoropropyl ether; 2,2,2-trifluoroethyl 1,1,2,2-tetrafluoroethyl ether; difluoromethyl 2,2,3,3-tetrafluoropropyl ether; propyl 1,1,2,2-tetrafluoroethyl ether; 1,1-difluoroethyl 2,2,2-trifluoroethyl ether; isopropyl 1,1,2,2-tetrafluoroethyl ether; bis(2,2-difluoroethyl)ether; or 1,1,2,2-tetrafluoroethyl isobutyl ether.

In aspects, the electrolyte may include, by volume, from 15% to 60% of the nonaqueous aprotic organic solvent, from 30% to 80% of the diluent, and from 5% to 10% of the flame retardant additive.

The above summary is not intended to represent every possible embodiment or every aspect of the present disclosure. Rather, the foregoing summary is intended to exemplify some of the novel aspects and features disclosed herein. The above features and advantages, and other features and advantages of the present disclosure, will be readily apparent from the following detailed description of representative embodiments and modes for carrying out the present disclosure when taken in connection with the accompanying drawings and the appended claims.

### BRIEF DESCRIPTION OF THE DRAWINGS

Illustrative embodiments will hereinafter be described in conjunction with the appended drawings, wherein like designations denote like elements, and wherein:

FIG. 1 is a schematic side cross-sectional view of an electrochemical cell of a secondary lithium metal battery.

The present disclosure is susceptible to modifications and alternative forms, with representative embodiments shown by way of example in the drawings and described in detail below. Inventive aspects of this disclosure are not limited to the particular forms disclosed. Rather, the present disclosure is intended to cover modifications, equivalents, combinations, and alternatives falling within the scope of the disclosure as defined by the appended claims.

### DETAILED DESCRIPTION

The presently disclosed liquid electrolytes are formulated for use in electrochemical cells of lithium metal batteries to help prevent propagation of thermal runaway temperatures, for example, by quenching, suppressing, and/or terminating combustion chain reactions within the electrochemical cells.

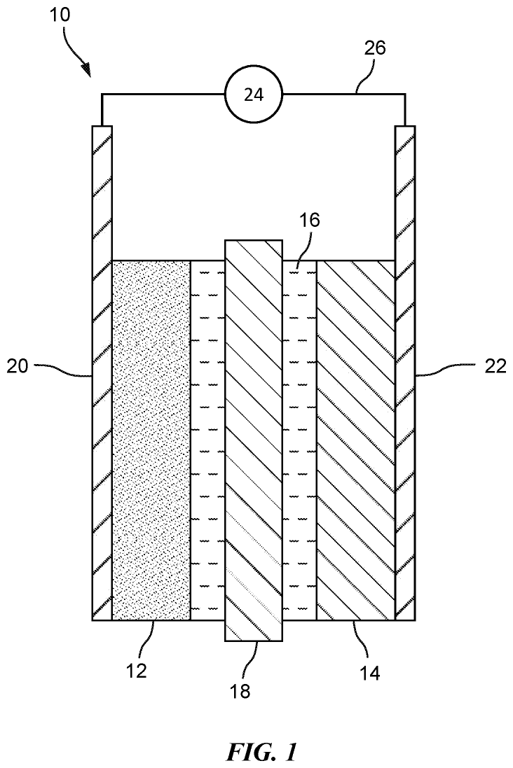

FIG. 1 depicts a schematic side cross-sectional view of an electrochemical cell 10 that may be combined with one or more additional electrochemical cells to form a secondary lithium battery, such as a lithium metal battery. The electrochemical cell 10 includes a positive electrode 12, a negative electrode 14 spaced apart from the positive electrode 12, an ionically conductive liquid electrolyte 16 that provides a medium for the conduction of lithium ions between the positive electrode 12 and the negative electrode 14, and a porous separator 18 that electrically isolates the positive and negative electrodes 12, 14 from each other while allowing lithium ions to pass therethrough. The positive electrode 12 is disposed on a major surface of a positive electrode current collector 20, and the negative electrode 14 is disposed on a major surface of a negative electrode current collector 22. In practice, the positive and negative electrode current collectors 20, 22 may be electrically coupled to a power source or load 24 via an external circuit 26.

The electrolyte 16 infiltrates the pores of the porous separator 18 and is in physical and ionic contact with the positive and negative electrodes 12, 14. The electrolyte 16 is formulated to facilitate the transport of lithium ions between the positive and negative electrodes 12, 14 and, when the electrochemical cell 10 is exposed to thermal runaway temperatures (e.g., temperatures greater than about 80° C.), the electrolyte 16 is formulated to prevent thermal runaway propagation, for example, by quenching, suppressing, and/or terminating combustion chain reactions within the electrochemical cell 10.

The electrolyte 16 comprises an organic solvent, a lithium salt dissolved in the organic solvent, a flame retardant additive, and optionally a diluent. The organic solvent in the electrolyte 16 may include one or more nonaqueous aprotic organic solvating solvents. The one or more solvating solvents in the organic solvent of the electrolyte 16 may be selected to facilitate dissolution of the lithium salt in the electrolyte 16 and to inhibit formation of lithium dendrites on the negative electrode 14 during repeated charging cycles of the electrochemical cell 10. In aspects, the one or more solvating solvents may comprise dimethoxy ethane (DME), dimethoxy propane (DMP), ethylene carbonate (EC), propylene carbonate (PC), and/or fluoroethylene carbonate (FEC). In aspects, the one or more solvating solvents may consist essentially of dimethoxy ethane, dimethoxy propane, or fluoroethylene carbonate. The organic solvent may constitute, by volume, from about 10% to about 90% of the electrolyte 16. When the electrolyte 16 does not include a diluent, the organic solvent may constitute, by volume, from about 90% to about 99% of the electrolyte 16. When the electrolyte 16 includes a diluent, the organic solvent may constitute, by volume, from about 10% to about 89% of the electrolyte 16.

In aspects where the electrochemically active material of the positive electrode 12 is formulated for charging to high voltages (e.g., greater than 4.3V vs. Li/Li), the organic solvent of the electrolyte 16 may be substantially free of carbonate-based organic solvents. For example, in aspects where the electrochemically active material of the positive electrode 12 comprises a high-nickel content layered oxide, the organic solvent of the electrolyte 16 may include, by volume, less than 5%, less than 2%, or less than 1% carbonate-based organic solvents. Examples of carbonate-based organic solvents include: ethylene carbonate, propylene carbonate, dimethyl carbonate, diethyl carbonate, ethyl methyl carbonate, and fluoroethylene carbonate.

The optional diluent in the electrolyte 16 may be selected to provide the electrolyte 16 with a desirable combination of low viscosity and high ionic conductivity. In aspects, the diluent may be a fluorinated ether. For example, the diluent may comprise 1,1,2,2-tetrafluoroethyl-2,2,3,3-tetrafluoropropyl ether (TTE); 1,2,2,2-tetrafluoroethyl methyl ether; n-Butyl-1,1,2,2-tetrafluoroethyl ether; 1H,1H,2′H,3H-Decafluorodipropyl ether; bis(2,2,2-trifluoroethyl)ether; ethyl 1,1,2,2-tetrafluoroethyl ether; difluoromethyl-2,2,3,3,3-pentafluoropropyl ether; 2,2,2-trifluoroethyl 1,1,2,2-tetrafluoroethyl ether; difluoromethyl 2,2,3,3-tetrafluoropropyl ether; propyl 1,1,2,2-tetrafluoroethyl ether; 1,1-difluoroethyl 2,2,2-trifluoroethyl ether; isopropyl 1,1,2,2-tetrafluoroethyl ether; bis(2,2-difluoroethyl)ether; and/or 1,1,2,2-tetrafluoroethyl isobutyl ether. In aspects, the diluent may consist essentially of 1,1,2,2-tetrafluoroethyl-2,2,3,3-tetrafluoropropyl ether. When present in the electrolyte 16, the diluent may constitute, by volume, from about 10% to about 89% of the electrolyte 16.

For example, in aspects where the electrolyte 16 includes the organic solvent and the diluent, the electrolyte 16 may include, by volume, 15% to 60% organic solvent, 30% to 80% diluent, and 5% to 10% flame retardant additive.

The lithium salt in the electrolyte 16 may be selected to exhibit good solubility in the organic solvent. In aspects, the lithium salt may comprise lithium bis(fluorosulfonyl)imide (LiN(FSO₂)₂, or LiFSI); lithium hexafluorophosphate (LiPF₆); lithium perchlorate (LiClO₄); lithium tetrachloroaluminate (LiAlCl₄); lithium iodide (LiI); lithium bromide (LiBr); lithium thiocyanate (LiSCN); lithium tetrafluoroborate (LiBF₄); lithium tetraphenylborate (LiB(C₆H₅)₄); lithium hexafluoroarsenate (LiAsF₆); lithium trifluoromethanesulfonate (LiCF₃SO₃); lithium bis(fluorosulfonyl)imide (LiN(FSO₂)₂); lithium bis(trifluoromethylsulfonyl)imide (LiN(CF₃SO₂)₂, or LiTFSI); lithium bis(oxalate) borate (LiB(C₂O₄)₂, or LiBOB); lithium difluoro(oxalato)borate (LiBF₂(C₂O₄), or LiODFB); lithium tris(pentafluoroethyl)-trifluorophosphate (LiPF₃(C₂F₅)₃, or LiFAP); lithium bis(trifluoromethyl)-tetrafluorophosphate (LiPF₄(CF₃)₂); lithium tetrafluorooxalatophosphate (LiPF₄(C₂O₄), or LiFOP); lithium tris(trifluoromethyl)trifluorophosphate (LiPF₃(CF₃)₃); lithium trifluoromethanesulfonate (LiSO₃CF₃); and/or lithium nitrate (LiNO₃). In aspects, the lithium salt may consist essentially of lithium bis(fluorosulfonyl)imide.

The molarity or molar concentration of the lithium salt in the electrolyte 16 (moles of lithium salt per liter of electrolyte 16, M) may be in a range of from 0.5 M to 5.0 M. In aspects where the organic solvent of the electrolyte 16 consists essentially of the one or more solvating solvents and does not include a diluent, the electrolyte 16 may be a high-salt-concentration electrolyte (HCE) and the molar concentration of the lithium salt in the electrolyte 16 may be greater than 2.0 M or greater than 2.5 M, less than 5.0 M or less than 4.0 M, or from 2.0 M to 5.0 M or from 2.5 M to 4.0 M. In aspects where the organic solvent of the electrolyte 16 includes one or more solvating solvents and a fluorinated ether diluent, the electrolyte 16 may be a localized high-salt-concentration electrolyte (LHCE) and the molar concentration of the lithium salt in the electrolyte 16 may be greater than 0.5 M or greater than 1.0 M, less than 2.5 M or less than 2.0 M, or from 0.5 M to 2.5 M or from 1.0 M to 2.0 M.

The flame retardant additive in the electrolyte 16 comprises one or more phosphorus (P)—containing compounds that thermally decompose when exposed to thermal runaway temperatures (e.g., temperatures greater than about 80° C., greater than about 120° C., or greater than about 250° C.). Without intending to be bound by theory, it is believed that, at thermal runaway temperatures, the flame retardant additive in the electrolyte 16 can thermally decompose to produce certain gaseous species that quench, remove, or interfere with free radical-initiated combustion chain reactions occurring in the electrochemical cell 10.

The flame retardant additive may comprise an organophosphate compound, an organophosphite compound, organophosphonate compound, and/or a phosphazene compound. In aspects, the flame retardant additive in the electrolyte 16 may be an alkyl or aryl organophosphate compound represented by the following chemical formula:

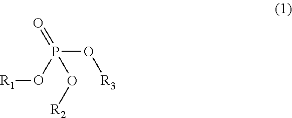

wherein R₁, R₂, and/or R₃ may be C1-C4 alkyl groups and/or aryl groups having 5 to 6 carbon atoms, e.g., phenyl groups (—C₆H₅). In aspects, the organophosphate compound of formula (1) may be a fluorinated organophosphate compound. In such case, R₁, R₂, and/or R₃ in the organophosphate compound of formula (1) may be C1-C4 polyfluoroalkyl groups and/or polyfluoroaryl groups. Examples of C1-C4 polyfluoroalkyl groups include polyfluoromethyl groups (e.g., trifluoromethyl groups, —CF₃) and/or polyfluoroethyl groups.

In aspects, R₁, R₂, and R₃ in the organophosphate compound of formula (1) each may be a trifluoroethyl group (e.g., —CH₂CF₃). In such case, the flame retardant additive may comprise tris(2,2,2-trifluoroethyl) phosphate (TFEPO), CAS No. 358-63-4, and may be represented by the following chemical formula:

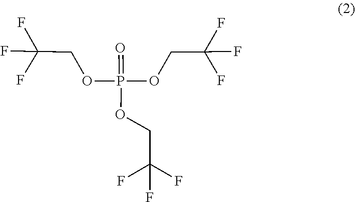 [SMILES: O=P(OCC(F)(F)F)(OCC(F)(F)F)OCC(F)(F)F]

In aspects, the flame retardant additive in the electrolyte 16 may be an alkyl or aryl organophosphite compound represented by the following chemical formula:

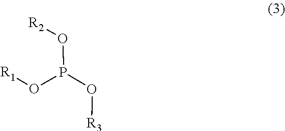

wherein R₁, R₂, and/or R₃ may be C1-C4 alkyl groups and/or aryl groups having 5 to 6 carbon atoms, e.g., phenyl groups (—C₆H₅). In aspects, the organophosphite compound of formula (3) may be a fluorinated organophosphite compound. In such case, R₁, R₂, and/or R₃ in the organophosphite compound of formula (3) may be C1-C4 polyfluoroalkyl groups and/or polyfluoroaryl groups. Examples of C1-C4 polyfluoroalkyl groups include polyfluoromethyl groups and/or polyfluoroethyl groups.

In aspects, R₁, R₂, and R₃ in the organophosphite compound of formula (3) each may be a trifluoroethyl group (e.g., —CH₂CF₃). In such case, the flame retardant additive may comprise tris(2,2,2-trifluoroethyl) phosphite (TFEP), CAS No. 370-69-4, and may be represented by the following chemical formula:

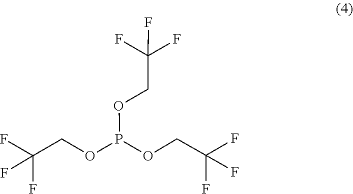 [SMILES: FC(F)(F)COP(OCC(F)(F)F)OCC(F)(F)F]

As another example, R₁, R₂, and R₃ in the organophosphite compound of formula (3) each may be a phenyl group (—C₆H₅). In such case, the flame retardant additive may comprise triphenyl phosphite (TPP), CAS No. 101-02-0, and may be represented by the following chemical formula:

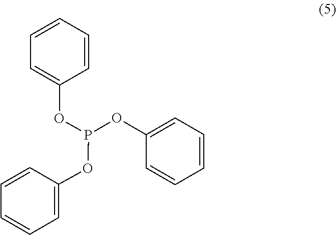 [SMILES: c1ccc(OP(Oc2ccccc2)Oc2ccccc2)cc1]

In aspects, the flame retardant additive in the electrolyte 16 may be an alkyl or aryl organophosphonate compound represented by the following chemical formula:

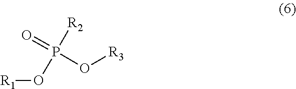

wherein R₁, R₂, and/or R₃ may be C1-C4 alkyl groups and/or aryl groups having 5 to 6 carbon atoms. For example, R₁, R₂, and/or R₃ in the organophosphonate compound of formula (6) may be methyl groups (—CH₃), ethyl groups (—CH₂CH₃), and/or phenyl groups (—C₆H₅). In aspects, the organophosphonate compound of formula (6) may be a fluorinated organophosphonate compound. In such case, R₁, R₂, and/or R₃ in the organophosphonate compound of formula (6) may be C1-C4 polyfluoroalkyl groups and/or polyfluoroaryl groups having 5 to 6 carbon atoms.

In aspects, R₁, R₂, and R₃ in the organophosphonate compound of formula (6) each may be an ethyl group (—CH₂CH₃). In such case, the flame retardant additive may comprise diethyl ethylphosphonate (DEEP), CAS No. 78-38-6, and may be represented by the following chemical formula:

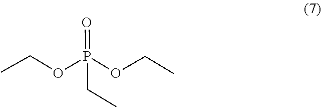

As another example, in the organophosphonate compound of formula (6), R₂ may be a phenyl group (—C₆H₅) and R₁ and R₃ may be ethyl groups (—CH₂CH₃). In such case, the flame retardant additive may comprise diethyl phenylphosphonate (DEPP), CAS No. 1754-49-0, and may be represented by the following chemical formula:

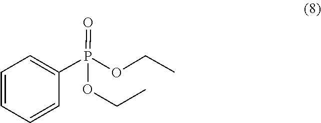

In aspects, the flame retardant additive in the electrolyte 16 may be an alkyl or aryl phosphazene compound. For example, the flame retardant additive in the electrolyte 16 may be an aryl phosphazene compound represented by the following chemical formula:

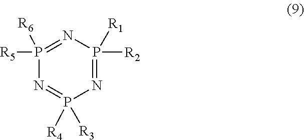

wherein R₁, R₂, R₃, R₄, R₅, and/or R₆ may be fluorine atoms (F), C1-C4 alkyl groups, C1-C4 alkoxy groups, aryl groups having 5 to 6 carbon atoms, and/or aryloxy groups having 5 to 6 carbon atoms. For example, R₁, R₂, R₃, R₄, R₅, and/or R₆ in the aryl phosphazene compound of formula (9) may be methyl groups (—CH₃), methoxy groups (—OCH₃), ethyl groups (—CH₂CH₃), ethoxy groups (—OCH₂CH₃), phenyl groups (—C6H₅), and/or phenoxy groups (—OC₆H₅). In aspects, the aryl phosphazene compound of formula (9) may be a fluorinated aryl phosphazene compound. In such case, R₁, R₂, R₃, R₄, R₅, and/or R₆ in the aryl phosphazene compound of formula (9) may be fluorine atoms (F), C1-C4 polyfluoroalkyl groups, C1-C4 polyfluoroalkoxy groups, polyfluoroaryl groups having 5 to 6 carbon atoms, and/or polyfluoroaryloxy groups having 5 to 6 carbon atoms.

In aspects, in the aryl phosphazene compound of formula (9), R₂ may be an ethoxy group (—OCH₂CH₃) and R₁, R₃, R₄, R₅, and R₆ may be fluorine atoms (F). In such case, the flame retardant additive may comprise 2-ethoxy-2,4,4,6,6-pentafluoro-1,3,5,2,4,6-triazatriphosphorine, CAS No. 33027-66-6, and may be represented by the following chemical formula:

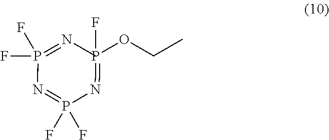

As another example, in the aryl phosphazene compound of formula (9), R₂ may be a phenoxy group (—OC₆H₅) and R₁, R₃, R₄, R₅, and R₆ may be fluorine atoms (F). In such case, the flame retardant additive may comprise pentafluoro(phenoxy)cyclotriphosphazene, CAS No. 33027-68-8, and may be represented by the following chemical formula:

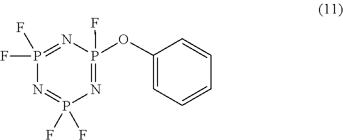 [SMILES: FP1(F)=NP(F)(F)=NP(F)(Oc2ccccc2)=N1]

The flame retardant additive may constitute, by volume, greater than 1% or greater than 2%, less than 10% or less than 6%, or from 1% to 10% or from 2% to 6% of the electrolyte 16. In aspects, the flame retardant additive may constitute, by volume, about 5% of the electrolyte 16.

The porous separator 18 is configured to physically separate the positive electrode 12 and the negative electrode 14 from one another while permitting lithium ions to pass therethrough. The porous separator 18 exhibits an open microporous structure and may comprise an organic and/or inorganic material that can physically separate and electrically insulate the positive and negative electrodes 12, 14 from each other while permitting the free flow of ions therebetween. The porous separator 18 may comprise a non-woven material, e.g., a manufactured sheet, web, or mat of directionally or randomly oriented fibers. The porous separator 18 may comprise a microporous polymeric material, e.g., a microporous polyolefin-based membrane or film. For example, the porous separator 18 may comprise a single polyolefin or a combination of polyolefins, such as polyethylene (PE), polypropylene (PP), polyamide (PA), poly(tetrafluoroethylene) (PTFE), polyvinylidene fluoride (PVdF), and/or poly(vinyl chloride) (PVC). In one form, the porous separator 18 may comprise a laminate of one or more polymeric materials, such as a laminate of PE and PP. In aspects, the porous separator 18 may include a ceramic coating and/or a heat-resistant material coating, which may be disposed on one or both major facing surfaces of the porous separator 18 and may alumina (Al₂O₃) and/or silica (SiO2). The porous separator 18 may have a thickness in a range of from 5 μm to 30 μm and a porosity in a range of from 25% to 75%.

The positive electrode 12 is porous and may comprise one or more electrochemically active materials that can undergo a reversible redox reaction with lithium, e.g., a material that can sufficiently undergo lithium intercalation and deintercalation, alloying and dealloying, or plating and stripping. In one form, the positive electrode 12 may comprise an intercalation host material that can undergo the reversible insertion or intercalation of lithium ions. In such case, the intercalation host material of the positive electrode 12 may comprise a layered oxide represented by the formula LiMeO₂, an olivine-type oxide represented by the formula LiMePO₄, a spinel-type oxide represented by the formula LiMe₂O₄, a tavorite represented by one or both of the following formulas LiMeSO₄F or LiMePO₄F, or a combination thereof, where Me is a transition metal (e.g., Co, Ni, Mn, Fe, Al, V, or a combination thereof). In another form, the positive electrode material 12 may comprise a conversion material including a component that can undergo a reversible electrochemical reaction with lithium, in which the component undergoes a phase change or a change in crystalline structure accompanied by a change in oxidation state. In such case, the conversion material of the positive electrode 12 may comprise sulfur, selenium, tellurium, iodine, a halide (e.g., a fluoride or chloride), sulfide, selenide, telluride, iodide, phosphide, nitride, oxide, oxysulfide, oxyfluoride, sulfur-fluoride, sulfur-oxyfluoride, or a lithium and/or metal compound thereof. Examples of suitable metals for inclusion in the conversion material of the positive electrode 12 include iron, manganese, nickel, copper, and cobalt. In aspects, the positive electrode 12 may include an electrochemically active material in the form of a high-nickel content layered oxide: LiNi₁₋ₓMₓO₂, where M=Co, Mn, and/or Al, and wherein x≤0.4. For example, the positive electrode 12 may include a high-nickel content lithium nickel cobalt manganese oxide (NCM): LiNi_{1-a-b}CoₐMn_{b}O₂, wherein a=0.1-0.2 and b=0.1-0.2.

The electrochemically active material of the positive electrode 12 may be intermingled with a polymeric binder to provide the positive electrode 12 with structural integrity. Examples of polymeric binders include polyvinylidene fluoride (PVdF), ethylene propylene diene monomer (EPDM) rubber, styrene butadiene rubber (SBR), carboxymethyl cellulose (CMC), polyacrylic acid, and mixtures thereof. The positive electrode 12 optionally may include particles of an electrically conductive material, which may comprise very fine particles of, for example, high-surface area carbon black. The electrochemically active material(s) may account for, by weight, from 50% to 90% of the positive electrode 12, the polymeric binder may account for, by weight, from 5% to 30% of the positive electrode 12, and the electrically conductive material may account for, by weight, 5% to 40% of the positive electrode 12.

The negative electrode 14 may be in the form of a nonporous layer of lithium metal. In such case, the negative electrode 14 may comprise a lithium metal alloy or may consist essentially of lithium (Li) metal. For example, the negative electrode 14 may comprise, by weight, greater than 97% lithium or greater than 99% lithium. As such, in aspects, the negative electrode 14 does not comprise other elements or compounds that undergo a reversible redox reaction with lithium during operation of the electrochemical cell 10. For example, in aspects, the negative electrode 14 does not comprise an intercalation host material that is formulated to undergo the reversible insertion or intercalation of lithium ions or an alloying material that can electrochemically alloy and form compound phases with lithium. In addition, in aspects, the negative electrode 14 does not comprise a conversion material or an alloy material that can electrochemically alloy and form compound phases with lithium. Examples of materials that may be excluded from the negative electrode 14 of the present disclosure include carbon-based materials (e.g., graphite, activated carbon, carbon black, and graphene), silicon and silicon-based materials, tin oxide, aluminum, indium, zinc, cadmium, lead, germanium, tin, antimony, titanium oxide, lithium titanium oxide, lithium titanate, lithium oxide, metal oxides (e.g., iron oxide, cobalt oxide, manganese oxide, copper oxide, nickel oxide, chromium oxide, ruthenium oxide, and/or molybdenum oxide), metal phosphides, metal sulfides, and metal nitrides (e.g., phosphides, sulfides, and/or nitrides or iron, manganese, nickel, copper, and/or cobalt). In aspects, the negative electrode 14 does not comprise a polymeric binder. Examples of polymeric binders that may be excluded from the negative electrode 14 of the present disclosure include polyvinylidene fluoride (PVdF), ethylene propylene diene monomer (EPDM) rubber, styrene butadiene rubber (SBR), carboxymethyl cellulose (CMC), and polyacrylic acid. The negative electrode 14 may have a thickness in a range of from 5 micrometers to 600 micrometers.

The positive and negative electrode current collectors 20, 22 may be in the form of thin and flexible porous or non-porous electrically conductive metallic substrates and may comprise a metallic material that is capable of collecting and reversibly passing free electrons to and from their respective electrodes 12, 14. The term “metallic,” as used herein refers to a material that predominantly comprises one or more metals. As such, a metallic material may comprise a single metal, more than one metal (in alloy form or otherwise), or both one or more metals and one or more other non-metal components in elemental or compound form. For example, the positive and negative electrode current collectors 20, 22 may comprise an electrically conductive metal or metal alloy, e.g., a transition metal or an alloy thereof. In aspects, the positive electrode current collector 20 may comprise aluminum (Al), nickel (Ni), or an iron (Fe) alloy (e.g., stainless steel) and the negative electrode current collector 22 may comprise copper (Cu), nickel (Ni), an iron (Fe) alloy (e.g., stainless steel), or titanium (Ti). Other electrically conductive metals may of course be used, if desired.

These and other benefits will be readily appreciated by those of ordinary skill in the art in view of the forgoing disclosure.

While some of the best modes and other embodiments have been described in detail, various alternative designs and embodiments exist for practicing the present teachings defined in the appended claims. Those skilled in the art will recognize that modifications may be made to the disclosed embodiments without departing from the scope of the present disclosure. Moreover, the present concepts expressly include combinations and sub-combinations of the described elements and features. The detailed description and the drawings are supportive and descriptive of the present teachings, with the scope of the present teachings defined solely by the claims.

What is claimed is:

1. An electrolyte for a lithium metal battery, the electrolyte comprising:
a nonaqueous aprotic organic solvent;
a lithium salt dissolved in the nonaqueous aprotic organic solvent; and
1% to 10%, by volume, of a flame retardant additive,
wherein the flame retardant additive is at least one of an organophosphate compound, an organophosphite compound, organophosphonate compound, or a phosphazene compound.

2. The electrolyte of claim 1 wherein the flame retardant additive includes at least one of tris(2,2,2-trifluoroethyl) phosphate; tris(2,2,2-trifluoroethyl) phosphite; triphenyl phosphite; diethyl ethylphosphonate; diethyl phenylphosphonate; 2-ethoxy-2,4,4,6,6-pentafluoro-1,3,5,2,4,6-triazatriphosphorine; or pentafluoro(phenoxy)cyclotriphosphazene.

3. The electrolyte of claim 1 wherein the nonaqueous aprotic organic solvent includes at least one of dimethoxy ethane, dimethoxy propane, ethylene carbonate, propylene carbonate, or fluoroethylene carbonate, and wherein the nonaqueous aprotic organic solvent constitutes, by volume, from 10% to 90% of the electrolyte.

4. The electrolyte of claim 1 further comprising a diluent, wherein the diluent is at least one of 1,1,2,2-tetrafluoroethyl-2,2,3,3-tetrafluoropropyl ether (TTE); 1,2,2,2-tetrafluoroethyl methyl ether; n-Butyl-1,1,2,2-tetrafluoroethyl ether; 1H,1H,2′H,3H-Decafluorodipropyl ether; bis(2,2,2-trifluoroethyl)ether; ethyl 1,1,2,2-tetrafluoroethyl ether; difluoromethyl-2,2,3,3,3-pentafluoropropyl ether; 2,2,2-trifluoroethyl 1,1,2,2-tetrafluoroethyl ether; difluoromethyl 2,2,3,3-tetrafluoropropyl ether; propyl 1,1,2,2-tetrafluoroethyl ether; 1,1-difluoroethyl 2,2,2-trifluoroethyl ether; isopropyl 1,1,2,2-tetrafluoroethyl ether; bis(2,2-difluoroethyl)ether; or 1,1,2,2-tetrafluoroethyl isobutyl ether, and wherein the diluent constitutes, by volume, from 10% to 89% of the electrolyte.

5. The electrolyte of claim 1 wherein the lithium salt is at least one of lithium bis(fluorosulfonyl)imide; lithium hexafluorophosphate; lithium perchlorate; lithium tetrachloroaluminate; lithium iodide; lithium bromide; lithium thiocyanate; lithium tetrafluoroborate; lithium tetraphenylborate; lithium hexafluoroarsenate; lithium trifluoromethanesulfonate; lithium bis(fluorosulfonyl)imide; lithium bis(trifluoromethylsulfonyl)imide; lithium bis(oxalate) borate; lithium difluoro(oxalato)borate; lithium tris(pentafluoroethyl)-trifluorophosphate; lithium bis(trifluoromethyl)-tetrafluorophosphate; lithium tetrafluorooxalatophosphate; lithium tris(trifluoromethyl)trifluorophosphate; lithium trifluoromethanesulfonate; or lithium nitrate, and wherein a molar concentration of the lithium salt in the electrolyte is in a range of from 0.5 M to 5.0 M.

6. An electrochemical cell for a lithium metal battery, the electrochemical cell comprising:
a lithium metal negative electrode;
a positive electrode spaced apart from the negative electrode, the positive electrode including a transition metal oxide that can undergo a reversible intercalation of lithium ions; and
an electrolyte in ionic contact with the lithium metal negative electrode and the positive electrode,
wherein the electrolyte includes:
a nonaqueous aprotic organic solvent;
a lithium salt dissolved in the nonaqueous aprotic organic solvent; and
1% to 10%, by volume, of a flame retardant additive,
wherein the flame retardant additive is at least one of an organophosphate compound, an organophosphite compound, organophosphonate compound, or a phosphazene compound.

7. The electrochemical cell of claim 6 wherein the flame retardant additive in the electrolyte is an organophosphate compound represented by the chemical formula: 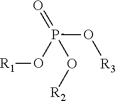
wherein R₁, R₂, and R₃ are each individually a C1-C4 alkyl group or an aryl group having 5 to 6 carbon atoms.

8. The electrochemical cell of claim 7 wherein the flame retardant additive in the electrolyte is tris(2,2,2-trifluoroethyl) phosphate.

9. The electrochemical cell of claim 6 wherein the flame retardant additive in the electrolyte is an organophosphite compound represented by the chemical formula: 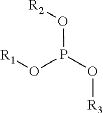
wherein R₁, R₂, and R₃ are each individually a C1-C4 alkyl group or an aryl group having 5 to 6 carbon atoms.

10. The electrochemical cell of claim 9 wherein the flame retardant additive in the electrolyte is at least one of tris(2,2,2-trifluoroethyl) phosphite or triphenyl phosphite.

11. The electrochemical cell of claim 6 wherein the flame retardant additive in the electrolyte is an organophosphonate compound represented by the chemical formula: 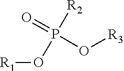
wherein R₁, R₂, and R₃ are each individually a C1-C4 alkyl group or an aryl group having 5 to 6 carbon atoms.

12. The electrochemical cell of claim 11 wherein the flame retardant additive in the electrolyte is at least one of diethyl ethylphosphonate or diethyl phenylphosphonate.

13. The electrochemical cell of claim 6 wherein the flame retardant additive in the electrolyte is an aryl phosphazene compound represented by the chemical formula: 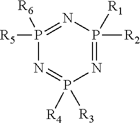
wherein R₁, R₂, R₃, R₄, R₅, and R₆ are each individually a fluorine atom, a C1-C4 alkyl group, a C1-C4 alkoxy group, an aryl group having 5 to 6 carbon atoms, or an aryloxy group having 5 to 6 carbon atoms.

14. The electrochemical cell of claim 13 wherein the flame retardant additive in the electrolyte is at least one of 2-ethoxy-2,4,4,6,6-pentafluoro-1,3,5,2,4,6-triazatriphosphorine or pentafluoro(phenoxy)cyclotriphosphazene.

15. The electrochemical cell of claim 6 wherein the transition metal oxide of the positive electrode is a high-nickel content lithium nickel cobalt manganese oxide having the chemical formula: LiNi_{1-a-b}CoₐMn_{b}O₂, wherein a=0.1-0.2 and b=0.1-0.2.

16. The electrochemical cell of claim 15 wherein the nonaqueous aprotic organic solvent in the electrolyte is at least one of dimethoxy ethane or dimethoxy propane, and wherein the electrolyte comprises, by volume, less than 5% of a carbonate-based organic solvent selected from the group consisting of ethylene carbonate, propylene carbonate, dimethyl carbonate, diethyl carbonate, ethyl methyl carbonate, and fluoroethylene carbonate.

17. The electrochemical cell of claim 6 wherein the lithium salt in the electrolyte is at least one of lithium bis(fluorosulfonyl)imide; lithium hexafluorophosphate; lithium perchlorate; lithium tetrachloroaluminate; lithium iodide; lithium bromide; lithium thiocyanate; lithium tetrafluoroborate; lithium tetraphenylborate; lithium hexafluoroarsenate; lithium trifluoromethanesulfonate; lithium bis(fluorosulfonyl)imide; lithium bis(trifluoromethylsulfonyl)imide; lithium bis(oxalate) borate; lithium difluoro(oxalato)borate; lithium tris(pentafluoroethyl)-trifluorophosphate; lithium bis(trifluoromethyl)-tetrafluorophosphate; lithium tetrafluorooxalatophosphate; lithium tris(trifluoromethyl)trifluorophosphate; lithium trifluoromethanesulfonate; or lithium nitrate.

18. The electrochemical cell of claim 6 wherein the lithium metal negative electrode comprises, by weight, greater than 97% lithium.

19. The electrochemical cell of claim 6 wherein the electrolyte includes a diluent, wherein the diluent in the electrolyte is at least one of 1,1,2,2-tetrafluoroethyl-2,2,3,3-tetrafluoropropyl ether (TTE); 1,2,2,2-tetrafluoroethyl methyl ether; n-Butyl-1,1,2,2-tetrafluoroethyl ether; 1H,1H,2′H,3H-Decafluorodipropyl ether; bis(2,2,2-trifluoroethyl)ether; ethyl 1,1,2,2-tetrafluoroethyl ether; difluoromethyl-2,2,3,3,3-pentafluoropropyl ether; 2,2,2-trifluoroethyl 1,1,2,2-tetrafluoroethyl ether; difluoromethyl 2,2,3,3-tetrafluoropropyl ether; propyl 1,1,2,2-tetrafluoroethyl ether; 1,1-difluoroethyl 2,2,2-trifluoroethyl ether; isopropyl 1,1,2,2-tetrafluoroethyl ether; bis(2,2-difluoroethyl)ether; or 1,1,2,2-tetrafluoroethyl isobutyl ether.

20. The electrochemical cell of claim 19 wherein the electrolyte includes, by volume, from 15% to 60% of the nonaqueous aprotic organic solvent, from 30% to 80% of the diluent, and from 5% to 10% of the flame retardant additive.
